(19) United States
(12) Patent Application Publication
(10) Pub. No.: US 2002/0085590 A1
(43) Pub. Date: Jul. 4, 2002

(54) Method and apparatus for inserting user data into sonet data communications channel

(76) Inventor: Bradley J. Booth, Austin, TX (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/752,074

(22) Filed: Dec. 29, 2000

(51) Int. Cl. H04J 3/24; H04J 3/04

(52) U.S. Cl. 370/535; 370/473

(57) ABSTRACT

A SONET framer having a user data input that feeds a data communication channel. The data communication channel is located within a transport overhead. The transport overhead is appended to a SONET payload envelope. A method of inserting user data into a data communication channel. The data communication channel is located within a transport overhead. The transport overhead appended to a SONET payload envelope.

### FIELD OF INVENTION

The field of invention relates generally to networking; and more specifically, to a method and apparatus for inserting user data into a SONET data communications channel.

### BACKGROUND

FIG. 1 shows a standard format 100 for an STS-1 signal. STS-1 signals are typically viewed as basic building blocks for Synchronous Optical NETwork (SONET) based architectures. An STS-1 signal includes a payload 101, a path overhead 102 and a transport overhead 103. The payload 101 and the path overhead 102, the combination of which are referred to as the synchronous payload envelope (SPE), consume 783 bytes of information (i.e., 87 bytes×9 bytes).

A transport overhead 103 is appended to each SPE to form an STS-1 signal. The transport overhead 103 includes 27 bytes per SPE (i.e., 3 bytes×9 bytes). Thus, the standard format for an STS-1 signal is an 810 byte structure (i.e., 783 bytes+27 bytes). To construct an STS-1 signal, the format 100 outlined in FIG. 1 is transmitted from a first network node to a second network node every 125 us. Thus, an STS-1 signal corresponds to a 51.84 Mbps signal (i.e., 810 bytes/125 us=51.84 Mbps).

A SYNnchronous Optical Network (SONET) frame may be viewed as a timed data structure that carries “n” standard STS-1 signal formats 100 per 125 us. For example, a SONET networking line having only one STS-1 signal format 100 per frame (i.e., n=1) corresponds to a line speed of 51.840 Mbps (i.e., 810 bytes every 125 us). Similarly, a SONET networking line having forty eight STS-1 signal formats per frame (i.e., n=48) corresponds to a line speed of 2.488 Gbps (i.e., 38880 bytes every 125 us), and a SONET networking line having one hundred and ninety two STS-1 signal formats per frame (i.e., n=192) corresponds to a line speed of 9.952 Gbps (i.e., 155520 bytes every 125 us). Note that if the applicable networking line is optical “OC” is typically used instead of “STS” (e.g., OC-48, OC-192 etc.).

The transport overhead 103 is divided into a “section” overhead and a “line” overhead (which are not shown in FIG. 1 for simplicity). The section overhead consumes nine bytes of information within the transport overhead 103 and the line overhead consumes eighteen bytes of information within the transport overhead 103.

Three bytes of the section overhead are reserved for a section data communication channel (DCC) that is traditionally used to communicate control information for repeaters within a SONET network. Nine bytes of the line overhead are reserved for a line DCC that is traditionally used to communicate control information for terminating equipment within a SONET network.

Control information is used to control the operation of the network and is therefore distinguishable from the random “customer” data that is transported by the network within payload 101. Both the section DCC and line DCC are traditionally used to carry alarms, network maintenance data, commands, network performance data and other administrative data to/from any node within a larger SONET network.

Three bytes per STS-1 correspond to a 192 kbps communication channel (i.e., 24 bits/125 us=192 kbps) while nine bytes per STS-1 signal correspond to a 576 kbps communication channel (i.e., 72 bits/125 us=576 kbps). Thus, per STS-1 signal, the section DCC corresponds to a 192 kbps channel and the line DCC corresponds to a 576 kbps channel.

Note that the bandwidth of the DCC channels expand linearly with the line speed of a SONET networking line. For example, for an OC-192 SONET line, the bandwidth reserved for the line DCC corresponds to 36.864 Mbps (i.e., 192×192 kbps) while the bandwidth reserved for the section DCC corresponds to 110.592 Mbps (i.e., 192×576 kbps).

FIG. 2 shows a networking architecture 200 typically associated with Ethernet (E/N). Ethernet is any of the IEEE 802.3 based communication standards. Ethernet based networks are typically comprised of a switching hub 220 that is communicatively coupled to a plurality of client nodes 210₁ through 210ₙ. The switching hub 220 collects outbound traffic that is transmitted from each of its client nodes (e.g., along outbound network lines 203₁ through 203ₙ) and transmits inbound traffic to each of its client nodes (e.g., along inbound network lines 202₁ through 202ₙ).

The switching hub 220 allows the client nodes 210₁ through 210ₙ to communicate with one another or communicate with a larger network coupled to the switching hub (e.g., via trunk line 215). In alternate networking architectures, switching hub 220 may be replaced by a router.

### LIST OF FIGURES

FIG. 1 shows a standard format for an STS-1 signal.

FIG. 2 shows a switching hub based networking architecture.

FIG. 3 shows an STS-1 signal having high priority traffic allocation and low priority traffic allocation.

FIG. 4 shows an embodiment of a framer that may be used to implement the STS-1 signaling format shown in FIG. 3.

FIG. 5 shows an embodiment of a method that may be utilized by the framer of FIG. 4.

### DETAILED DESCRIPTION

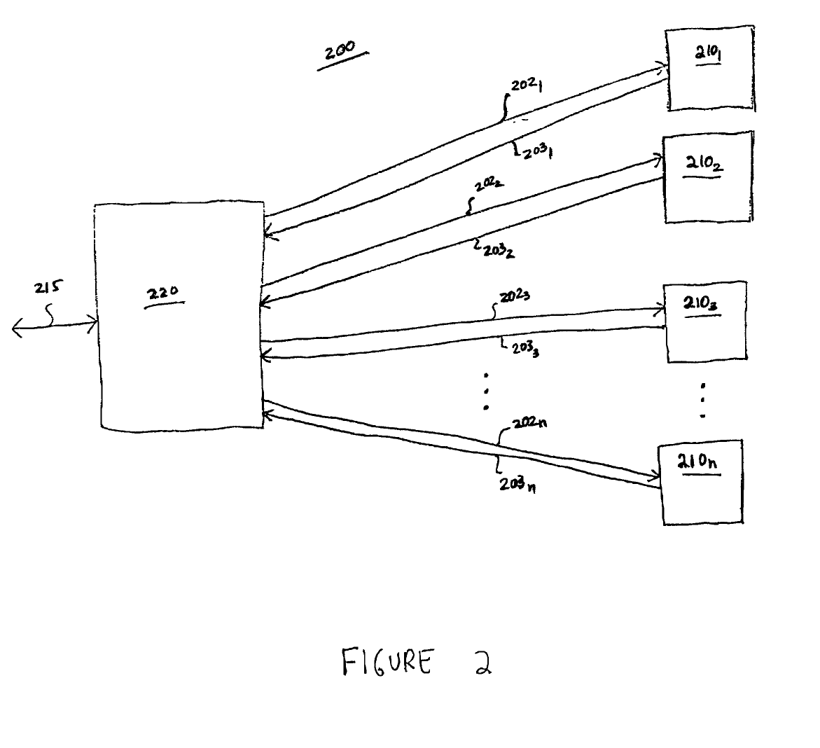

The Institute of Electronic and Electrical Engineers (IEEE) P802.3ae task force is developing a specification for a Wide Area Network (WAN) physical layer interface (PHY) that employs SONET OC-192c framing (hereinafter referred to as “10 Gbps E/N PHY”). The switching hub architecture discussed in FIG. 2 is an envisioned network architecture that is likely to be implemented with the 10 Gbps E/N PHY.

That is, for example, outbound network lines 203₁ through 203ₙ and inbound network lines 202₁ through 202ₙ may each correspond to an OC-192c SONET line and therefore may each possess a line speed of approximately 10 Gbps (recalling that the line speed of a SONET OC-192 line is 9.952 Gbps). Notably, the task force has not specified any use for the section DCC and line DCC discussed above in the background.

Networking technology is generally challenged with prioritizing the different types of traffic that exist. For example, real time voice traffic or real time video traffic (such as, respectively, a telephone call or video conference call) should suffer low latency (i.e., a small end to end transit time across the network) so that users of the network do not suffer through a cumbersome communication experience. Non real time traffic (such as emails, documents, etc.) generally can tolerate greater latency because the user is generally indifferent as to how long it takes to receive such information.

Network providers and their equipment suppliers may therefore wish to emphasize, in some manner, the ability to distinguish between the two types of traffic so that they may be treated differently. Specifically, real time traffic may be labeled as “high priority” and therefore provided a low latency path through the network while non real time traffic may be labeled as “low priority” and therefore provided a higher latency path through the network.

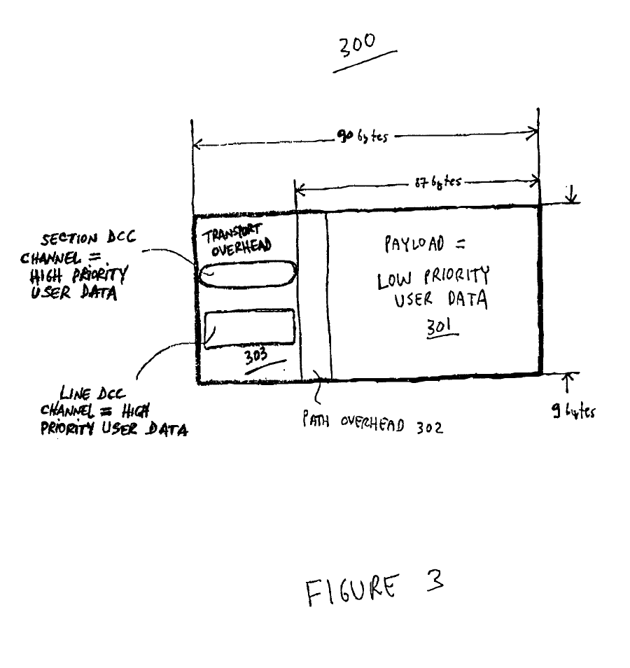

FIG. 3 shows an STS-1 signaling format 300 that allocates for high priority data within the transport overhead 303 and allocates for low priority data within the payload 301. In an embodiment, the section and line DCC channels within the transport overhead 303 are utilized to supply a combined bandwidth of 768 kbps per STS-1 signal for high priority user data.

Note that, unlike the prior art where the DCC channels are only used to transport control information, the approach of FIG. 3 utilizes the DCC channels to carry “random” customer data (also referred to as user data) that has been traditionally carried only within payload 301. That is, a user data is data offered by a customer of a network as opposed to the provider of a network (who offers control information data).

In an embodiment, low latency is provided for a user's high priority traffic by keeping the offered load of the high priority traffic equal to or less than the bandwidth of the DCC channels. For example in a further embodiment, if a particular user consumes one STS-1 signal, the user's combined high priority offered load (i.e., the rate at which the user's high priority traffic is presented to the network for transportation) is limited to 768 kbps or less. As a single STS-1 signal payload 301 corresponds to a data rate of 50.112 Mbps (i.e., 87 bytes×9 bytes per 125 us), note that the same user may be allowed to present a low priority offered load (i.e., the rate at which the user's low priority traffic is presented to the network for transportation) that is greater than 50.112 Mbps.

From basic queuing theory, as the user's low priority offered load increasingly exceeds 50.112 Mbps, the greater the delay will be imposed upon the user's low priority traffic. However, as discussed above, delay added to the transit time of low priority traffic is more easily tolerated than the delay added to high priority traffic.

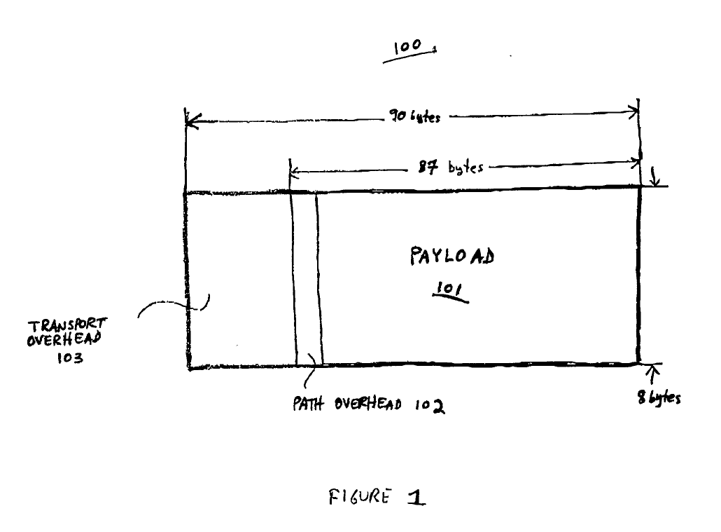

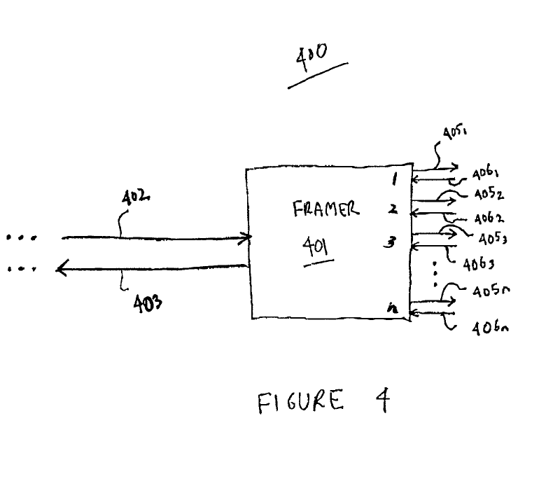

FIG. 4 shows an embodiment of a framer that may be used to implement the STS-1 signaling format shown in FIG. 3. A framer 401 is one or more semiconductor chips that provide framing organization for a network line. For example, the exemplary framer 401 of FIG. 1: 1) formats STS-1 signals into frames that are transmitted on an outbound networking line 403 to another network node (such as a switching hub if framer 401 corresponds to a framer located within in a client node); and 2) retrieves STS-1 signals from frames received from another network node on an inbound networking line 402.

In the case of outbound transmission, other portions of the networking system (i.e., a machine that acts as a node within a network such as a client node or switching hub) that house the framer 401 individually provide each STS-1 signal carried by the outbound network line 403 to the framer 401. For example, a first STS-1 signal is presented to the framer at input 406₁, a second STS-1 signal is presented to the framer at input 406₂, etc. Consequently, for example, the framer 401 maps into a SONET frame on outbound networking line 403: the STS-1 signal received at input 406₁; the STS-1 signal received at input 406₂; etc.

Correspondingly, in the case of inbound transmission, each STS-1 signal carried by the inbound network line 402 is individually presented by the framer 401 to higher layers of the networking system that houses the framer 401. For example, a first STS-1 signal received from a SONET from on network line 402 is mapped to framer output 405₁, a second STS-1 signal is mapped to framer output 405₂, etc.

Note that different types of framers may exist. In one respect, the granularity of the inbound and outbound signals may vary. For example, each of the individual inbound signals 405₁ through 405ₙ and each of the individual outbound signals 406₁ through 406ₙ may be comprised of a signal that consumes less bandwidth than an STS-1 signal (e.g., down to a 64 kbps signal) or more bandwidth than an STS-1 signal (e.g., each individual input signal may correspond to a group of STS-1 signals such as an STS-3 rate signal or an STS-12 rate signal, or higher).

Regardless of granularity, the framer 401 may be designed to include “high priority data” inputs for each outbound signal 406₁ through 406ₙ where the high priority data inputs accept an amount of data that is commensurate with the DCC bandwidth associated with the total number of STS-1 signals consumed by an outbound signal. For example, if framer 401 corresponds to an OC-192 framer that receives sixteen OC-12 rate outbound signals (i.e., n=16 in FIG. 4 where each outbound signal 406₁ through 406₁₆ corresponds to a 601.344 Mbps interface(50.112 Mbps×12), the input for each outbound signal 406₁ through 406ₙ includes an interface for receiving 9.216 Mbps worth of high priority data.

The 9.216 Mbps worth of high priority data is fed to the twenty four DCC channels (i.e., twelve section DCCs and twelve line DCCs) that are, per frame, associated with the twelve STS-1 payloads used to transport the low priority traffic of a single outbound signal. The framer 401 may be similarly designed to include “high priority data” outputs for each inbound signal 405₁ through 405ₙ where the high priority data outputs present an amount of data that is commensurate with the DCC bandwidth associated with the total number of STS-1 signals consumed by an inbound signal.

Regardless of the granularity (i.e., the number of STS-1 signals) associated with inbound signals 405₁ through 405ₙ and outbound signals 406₁ through 406ₙ, for each STS-1 signal worth of data processed by the framer, 768 kbps of bandwidth may be allocated for high priority user data. Note that various architectural approaches may be used to allocate the DCC channels for high priority user data.

For example, in one embodiment, the high priority user data transportation services that are provided by the line and section DCC channels for a particular STS-1 signal can only be used to support that user associated with the payload of that STS-1 signal. That is, if the line and section DCC channels within a particular STS-1 signal are used to carry a user's high priority data, the user's low priority data must be carried by the payload associated with the particular STS-1 signal.

Thus, for example, if a user is allocated for 3 STS-1 signals (e.g., an OC-3 rate user) the user is automatically allocated 2.304 Mbps worth of high priority data transportation (3×0.768 Mbps). If the user has no traffic to offer the DCC channels, the DCC channels are effectively “wasted” because other users may not gain access to them.

In an alternate architectural approach, the DCC channels associated with a particular STS-1 signal may be configured for any user irrespective of the user that is being serviced by the payload of the particular STS-1 signal. Here, the total DCC channel bandwidth for a SONET line (e.g., 192×0.768 Mbps=147.456 Mbps for an OC-192 line) is viewed as a 147.456 Mbps “pipe” that may be used to transport high priority traffic. The 147.456 Mbps pipe can service the high priority traffic of various users on an as needed basis.

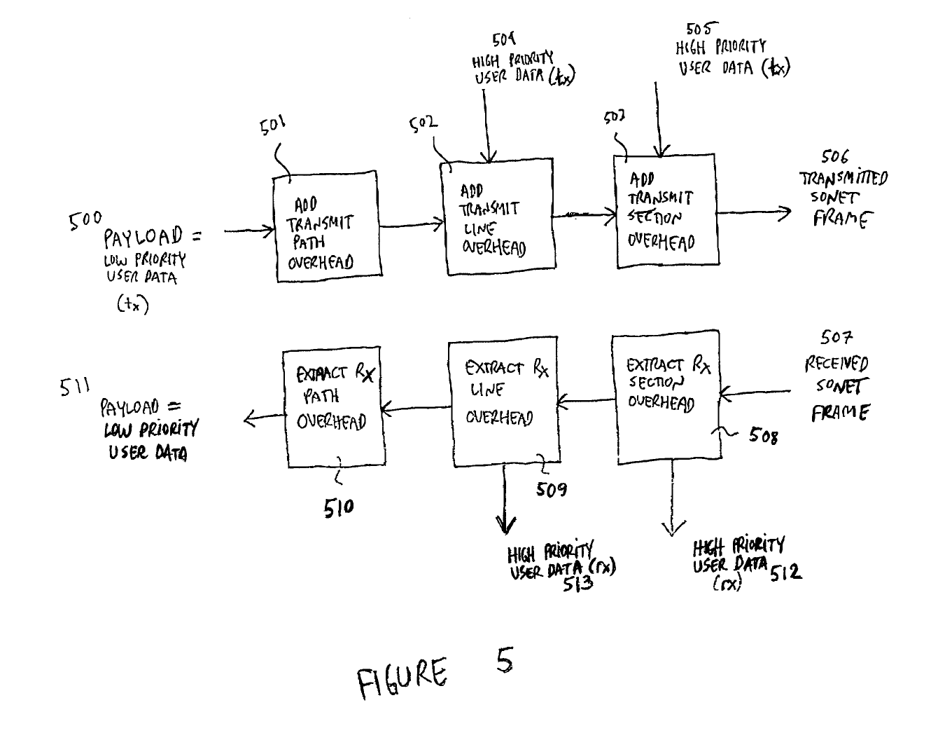

FIG. 5 shows an embodiment of a method that may be utilized by the framer of FIG. 4. Processing in both the outbound and inbound directions is shown. In the outbound direction, a payload 500 of low priority data is formed and the transmit path overhead is added 501. Then, the transmit line overhead is added 502. Associated with the addition 502 of the transmit line overhead is the introduction of high priority user data 504 into the bytes reserved for the line DCC.

Then, the transmit section overhead is added 503. Associated with the addition 503 of the transmit section overhead is the introduction of high priority user data 505 into the bytes reserved for the section DCC. At this point, the STS-1 signal may be mapped into and transmitted 506 within a SONET frame. The inbound process is effectively a reverse of the outbound process.

The section overhead of an STS-1 signal received from a SONET frame 507 is extracted 508. Associated with the extraction 508 of the section overhead is the extraction of high priority user data 512 found within the bytes reserved for the section DCC. Then, the line overhead is extracted 509. Associated with the extraction 509 of the line overhead is the extraction of high priority user data 513 found within the bytes reserved for the line DCC. The path overhead is then extracted 510 leaving low priority user data 511.

Note also that embodiments of the present description may be implemented not only within a semiconductor chip but also within machine readable media. For example, the designs discussed above may be stored upon and/or embedded within machine readable media associated with a design tool used for designing semiconductor devices. Examples include a netlist formatted in the VHSIC Hardware Description Language (VHDL) language, Verilog language or SPICE language. Some netlist examples include: a behavioral level netlist, a register transfer level (RTL) netlist, a gate level netlist and a transistor level netlist. Machine readable media also include media having layout information such as a GDS-II file. Furthermore, netlist files or other machine readable media for semiconductor chip design may be used in a simulation environment to perform the methods of the teachings described above.

Thus, it is also to be understood that embodiments of this invention may be used as or to support a software program executed upon some form of processing core (such as the CPU of a computer) or otherwise implemented or realized upon or within a machine readable medium. A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Note also that embodiments of the present description may be implemented not only within a semiconductor chip but also within machine readable media. For example, the designs discussed above may be stored upon and/or embedded within machine readable media associated with a design tool used for designing semiconductor devices. Examples include a netlist formatted in the VHSIC Hardware Description Language (VHDL) language, Verilog language or SPICE language. Some netlist examples include: a behaviorial level netlist, a register transfer level (RTL) netlist, a gate level netlist and a transistor level netlist. Machine readable media also include media having layout information such as a GDS-II file. Furthermore, netlist files or other machine readable media for semiconductor chip design may be used in a simulation environment to perform the methods of the teachings described above.

Thus, it is also to be understood that embodiments of this invention may be used as or to support a software program executed upon some form of processing core (such as the CPU of a computer) or otherwise implemented or realized upon or within a machine readable medium. A machine readable medium includes any mechanism for storing or transmitting information in a form readable by a machine (e.g., a computer). For example, a machine readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

1. An apparatus, comprising:
a SONET framer having a user data input that feeds a data communication channel, said data communication channel located within a transport overhead, said transport overhead appended to a SONET payload envelope.

2. The apparatus of claim 1 wherein said transport overhead further comprises a section overhead.

3. The apparatus of claim 2 wherein said data communication channel corresponds to a section data communication channel located within said section overhead.

4. The apparatus of claim 1 wherein said transport overhead further comprises a line overhead.

5. The apparatus of claim 4 wherein said data communication channel corresponds to a line data communication channel located within said line overhead.

6. The apparatus of claim 1 wherein said SONET payload envelope further comprises a payload.

7. The apparatus of claim 6 wherein said framer further comprises an inbound signal input that feeds said payload, said payload having low priority user data.

8. The apparatus of claim 1 wherein said user data further comprises voice traffic.

9. The apparatus of claim 1 wherein said user data further comprises video conferencing traffic.

10. An apparatus, comprising:
a networking system having a SONET framer, said SONET framer having a user data input that feeds a data communication channel, said data communication channel located within a transport overhead, said transport overhead appended to a SONET payload envelope.

11. The apparatus of claim 10 wherein said transport overhead further comprises a section overhead.

12. The apparatus of claim 11 wherein said data communication channel corresponds to a section data communication channel located within said section overhead.

13. The apparatus of claim 10 wherein said transport overhead further comprises a line overhead.

14. The apparatus of claim 14 wherein said data communication channel corresponds to a line data communication channel located within said line overhead.

15. The apparatus of claim 10 wherein said SONET payload envelope further comprises a payload.

16. The apparatus of claim 15 wherein said framer further comprises an inbound signal input that feeds said payload, said payload having low priority user data.

17. The apparatus of claim 10 wherein said user data further comprises voice traffic.

18. The apparatus of claim 10 wherein said user data further comprises video conferencing traffic.

19. The apparatus of claim 10 wherein said networking system is a switching hub.

20. The apparatus of claim 10 wherein said networking system is a router.

21. The apparatus of claim 10 wherein said networking system and said SONET framer are within an Ethernet network.

22. A method, comprising:
inserting user data into a data communication channel, said data communication channel located within a transport overhead, said transport overhead appended to a SONET payload envelope.

23. The method of claim 23 wherein said user data further comprises voice traffic.

24. The method of claim 22 wherein said user data further comprises video traffic.

25. The apparatus of claim 22 wherein said transport overhead further comprises a section overhead.

26. The apparatus of claim 25 wherein said data communication channel corresponds to a section data communication channel located within said section overhead.

27. The apparatus of claim 22 wherein said transport overhead further comprises a line overhead.

28. The apparatus of claim 27 wherein said data communication channel corresponds to a line data communication channel located within said line overhead.
